(19) United States
(12) Patent Application Publication
(10) Pub. No.: US 2026/0352591 A1
(43) Pub. Date: Nov. 5, 2026

(54) NETWORK SLICE GENERATION AND DYNAMIC ADJUSTMENT OF QUALITY-OF-SERVICE ATTRIBUTES

(71) Applicant: International Business Machines Corporation, Armonk, NY (US)

(72) Inventors: Dinesh C. Verma, New Castle, NY (US); Sagar Tayal, Ambala (IN)

(21) Appl. No.: 19/198,456

(22) Filed: May 5, 2025

(51) Int. Cl. H04L 45/302

(52) U.S. Cl. CPC H04L 45/302

(57) ABSTRACT

Network slice generation and dynamic adjustment of quality-of-service attributes include receiving a data stream that includes a plurality of data packets. A criticality index for each data packet of the plurality of data packets is obtained. The criticality index of each data packet indicates a measure of criticality of a processing task associated with a corresponding data packet of the plurality of data packets. A network slice of a communication network is generated for the data stream based on the criticality index of each data packet of the plurality of data packets. The network slice includes a sub-slice for each data packet of the plurality of data packets. Each data packet of the plurality of data packets is routed to one of an edge application of the communication network or a core application of the communication network based on the sub-slice of the corresponding data packet.

### BACKGROUND

The disclosure relates to communication networks and, more particularly, to wireless communication networks.

In modern communication networks, network slicing enables the creation of multiple logical networks on a shared physical infrastructure. With an increasing number of connected devices and real-time applications accessing resources of wireless networks, the demand for differentiated network performance continues to rise. Meeting the diverse requirements of Quality of Service (QoS) parameters necessitates dynamic and scalable network resource management. Any variation in QoS parameters can lead to performance degradation, impacting the efficiency and responsiveness of time-critical applications across various domains. As communication networks evolve to support diverse and demanding applications, traditional methods impose significant technical and operational limitations.

### SUMMARY

In various embodiments of the disclosure, a computer-implemented method for network slice generation and dynamic adjustment of quality-of-service attributes is described. The computer-implemented method includes receiving, by a computer, a data stream comprising a plurality of data packets. The computer-implemented method further includes obtaining, by the computer, a criticality index for each data packet of the plurality of data packets. The criticality index for each data packet of the plurality of data packets indicates a measure of criticality of a processing task associated with a corresponding data packet of the plurality of data packets. The computer-implemented method further includes generating, by the computer, a network slice of a communication network for the data stream based on the criticality index of each data packet of the plurality of data packets. The network slice comprises a sub-slice for each data packet of the plurality of data packets. The computer-implemented method further includes routing, by the computer, each data packet of the plurality of data packets to a processing application of the communication network based on the sub-slice of a corresponding data packet of the plurality of data packets.

In various embodiments of the disclosure, a computer system for network slice generation and dynamic adjustment of quality-of-service attributes is described. The computer system includes a processor set, one or more computer-readable storage media, and program instructions stored on the one or more computer-readable storage media. The program instructions are executable by the processor set to cause the processor set to receive a data stream comprising a plurality of data packets. Each data packet of the plurality of data packets comprises a criticality index that indicates a criticality of a processing task associated with a corresponding data packet of the plurality of data packets. The program instructions are executable by the processor set to further cause the processor set to generate a network slice of a communication network for the data stream based on the criticality index of each data packet of the plurality of data packets. The network slice comprises a sub-slice for each data packet of the plurality of data packets. The program instructions are executable by the processor set to further cause the processor set to route each data packet of the plurality of data packets to a processing application of the communication network based on the sub-slice of a corresponding data packet of the plurality of data packets.

In various embodiments of the disclosure, a computer-program product for data communication in a communication network is described.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF DRAWINGS

The following description will provide details of preferred embodiments with reference to the following figures where:

FIG. 1 is a diagram that illustrates a computing environment for network slice generation and dynamic adjustment of quality-of-service attributes in a communication network system, in accordance with an embodiment of the disclosure;

FIG. 2 is a diagram that illustrates a system for network slice generation and dynamic adjustment of quality-of-service attributes, in accordance with an embodiment of the disclosure;

FIG. 3 is a diagram that illustrates a flowchart of an exemplary method for network slice generation and dynamic adjustment of quality-of-service attributes, in accordance with an embodiment of the disclosure;

FIG. 4 is a diagram that illustrates an exemplary framework for network slice generation and dynamic adjustment of quality-of-service attributes, in accordance with an embodiment of the disclosure;

FIG. 5A is a diagram that illustrates a flowchart of a criticality index determination process of the framework of FIG. 4, in accordance with an embodiment of the disclosure;

FIG. 5B is a diagram that illustrates a flowchart of a network slice generation process of the framework of FIG. 4, in accordance with an embodiment of the disclosure;

FIG. 5C is a diagram that illustrates a flowchart of a data packet routing process of the framework of FIG. 4, in accordance with an embodiment of the disclosure;

FIG. 6 is a diagram that illustrates some examples of QoS attributes associated with data communication in a network, in accordance with an embodiment of the disclosure;

FIG. 7 is a diagram that illustrates a framework for the transmission of data packets, in accordance with an embodiment of the disclosure;

FIG. 8 is a diagram that illustrates a flowchart of a data packet routing process of the framework of FIG. 4, in accordance with an embodiment of the disclosure; and

FIG. 9 is a diagram that illustrates an example use case for network slice generation, in accordance with an embodiment of the disclosure.

### DETAILED DESCRIPTION

Network slicing plays a role in ensuring end-to-end Quality of Service (QoS) in modern and future cellular communication networks. As digital ecosystems evolve, a diverse range of time-critical applications such as smart agriculture, connected vehicles, remote healthcare, and emergency response systems demand tailored network performance. Many use cases such as smart agriculture, smart vehicles, field telehealth, and emergency response systems require extremely low latency guarantees. The applications often require stringent latency, reliability, and bandwidth guarantees to function effectively. For instance, real-time control systems in automation and remote operations require precise timing for data processing and transmission. However, ensuring ultra-low latency for such applications poses significant challenges, particularly in dynamic environments. Additionally, meeting stringent QoS requirements for real-time applications poses significant challenges.

For example, in smart agriculture applications, an autonomous field mower may classify a plant as a rose within 100 ms, with 50 ms allocated to network transmission and 50 ms for processing. Within the 50 ms allocated for network transmission, 10 ms may be dedicated to overall network latency, while the remaining 40 ms may be distributed across 10 network devices resulting in a strict 4 ms latency. This means almost the whole link has to be reserved for the slice. Meeting such precise timing constraints requires optimized network resource allocation to minimize delays. In scenarios where network latency per device is highly constrained, maintaining an exclusive network slice for each critical task becomes impractically expensive and resource-intensive.

Available network communication and slicing methods struggle to efficiently allocate resources while ensuring low latency and high processing power for critical applications (real-time patient monitoring, remote robotic surgery, emergency response coordination, and telemedicine consultations). Available QoS allocation strategies primarily distribute QoS requirements horizontally between the network and the application. However, the available methods impose strict constraints on both layers, resulting in inefficiencies, resource congestion, and challenges in maintaining guaranteed QoS. To meet stringent QoS demands, network operators often reserve large portions of bandwidth and processing power, making the approach inefficient and difficult to scale. Current solutions typically rely on end-to-end network slicing, where devices remain connected to the cloud or core network. However, such an approach introduces high latency, which is detrimental to real-time applications. As a result, existing approaches either over-allocate resources leading to inefficiencies and wastage, or under-allocate resources, causing service degradation for latency-sensitive applications.

To address these challenges, various embodiments described of the disclosure provide an adaptive and efficient system that distributes QoS attributes across both the network and application layers without overburdening network resources. Such a dynamic solution enables flexible QoS allocation, leveraging modern communication network capabilities to enhance efficiency scalability, and real-time processing for critical applications. In various embodiments, the system may dynamically generate network slices and allocate resources based on the criticality of individual data packets. Such a solution incorporates adaptive QoS optimization techniques, real-time monitoring, and intelligent decision-making to enhance network performance. The ability to prioritize high-criticality data packets while ensuring efficient resource utilization for less critical traffic helps to meet the demands of next-generation applications, such as autonomous systems, industrial IoT, and real-time communications.

For instance, in an industrial automation scenario, robotic arms on an assembly line exchange control signals within strict latency constraints (e.g., under 5 ms) to ensure synchronized operations. Meanwhile, non-critical telemetry data, such as temperature or vibration monitoring, tolerates higher latencies. With the systems and methods described in various embodiments, an intelligent QoS optimization system dynamically allocates network resources, ensuring that time-sensitive control data is prioritized without consuming excessive bandwidth for less critical tasks.

The present disclosure introduces a dual QoS slice framework that enhances network resource utilization while maintaining stringent QoS guarantees. Instead of horizontally splitting QoS attributes between network and application, the proposed system implements a vertical QoS split, allowing for efficient resource allocation. The framework introduces a multi-layered slicing approach, where a loosely bound end-to-end network slice facilitates broad connectivity across the core network, while a tightly bound end-to-edge network slice guarantees ultra-low-latency performance for critical tasks. By prioritizing time-sensitive processing at the edge, the approach ensures real-time decision-making for applications such as autonomous vehicles, remote surgical procedures, and industrial automation, where even milliseconds of delay may impact performance.

Core components of the system include a system equipped with advanced processors, memory, and storage to manage data flow and execute algorithms. The system leverages Edge Computing Nodes (ECN), Slice Management Logic (SML), Adaptive QoS Protocol (AQP), and Dynamic Flow Optimization (DFO) to intelligently classify, allocate, and monitor network slices. Each data packet of the plurality of data packets is assigned a criticality index, determining its priority and required network resources. Based on the classification, the system dynamically generates hierarchical network slices, comprising multiple sub-slices optimized for their specific latency and bandwidth needs. The adaptive slicing mechanism allows applications with stringent latency constraints such as smart agriculture, autonomous vehicles, and real-time medical diagnostics to offload time-sensitive processing to the edge, while less critical tasks are efficiently handled at the core network.

The disclosed solution enhances low-latency performance by dynamically generating network slices based on the criticality of each data packet of the plurality of data packets in a received data stream. The system determines the criticality index of each data packet of the plurality of data packets in the received data stream, where the criticality index represents the importance of the processing task associated with each data packet of the plurality of data packets. The system creates a network slice tailored to the data stream, which optimizes its latency and bandwidth needs. To ensure efficient resource utilization, the system routes each data packet of the plurality of data packets to either an edge application or a core application. Edge computing nodes handle latency-sensitive tasks that require immediate processing, while core computing nodes manage less time-sensitive tasks that benefit from centralized processing. This adaptive approach prevents network congestion, minimizes bandwidth wastage, and optimizes network resources by prioritizing high-criticality data for low-latency execution at the edge while directing lower-priority tasks to the core. As a result, by this network slicing approach the system improves network scalability, enhances reliability, and reduces operational costs, ensuring seamless service delivery for mission-critical applications such as smart agriculture, intelligent transportation, and real-time telehealth systems.

In various embodiments of the disclosure, a computer-implemented method for network slice generation and dynamic adjustment of quality-of-service attributes is described. The computer-implemented method includes receiving, by a computer, a data stream comprising a plurality of data packets. The computer-implemented method further includes obtaining, by the computer, a criticality index for each data packet of the plurality of data packets. The criticality index for each data packet of the plurality of data packets indicates a measure of criticality of a processing task associated with a corresponding data packet of the plurality of data packets. The computer-implemented method further includes generating, by the computer, a network slice of a communication network for the data stream based on the criticality index of each data packet of the plurality of data packets. The network slice comprises a sub-slice for each data packet of the plurality of data packets. The computer-implemented method further includes routing, by the computer, each data packet of the plurality of data packets to a processing application of the communication network based on the sub-slice of a corresponding data packet of the plurality of data packets.

In various embodiments of the disclosure, the computer-implemented method further includes controlling, by the computer, a transmitter to transmit each data packet of the plurality of data packets over the sub-slice of a corresponding data packet of the plurality of data packets.

In various embodiments of the disclosure, the obtaining of the criticality index for each data packet of the plurality of data packets includes extracting, by the computer, the criticality index of each data packet of the plurality of data packets from a corresponding data packet of the plurality of data packets.

In various embodiments of the disclosure, the obtaining of the criticality index for each data packet of the plurality of data packets includes receiving, by the computer, the criticality index of each data packet of the plurality of data packets from at least one edge computing node of the communication network. The at least one edge computing node is configured to process each data packet of the plurality of data packets based on a classification engine. The at least one edge computing node is further configured to determine the criticality index for each data packet of the plurality of data packets based on the processing of each data packet of the plurality of data packets.

In various embodiments of the disclosure, the generating of the network slice for the data stream includes creating, by the computer, a logical partition of the communication network for each data packet of the plurality of data packets. The generating of the network slice for the data stream further includes determining, by the computer, at least one desired Quality of Service (QoS) attribute for each data packet of the plurality of data packets, based on the criticality index of a corresponding data packet of the plurality of data packets. The generating of the network slice for the data stream further includes allocating, by the computer, network resources to the logical partition for each data packet of the plurality of data packets, based on the at least one desired QoS attribute of a corresponding data packet of the plurality of data packets.

In various embodiments of the disclosure, the plurality of data packets includes a first data packet and a second data packet. The criticality index of the first data packet is higher than the criticality index of the second data packet. The allocation of the network resources to the logical partition for each data packet of the plurality of data packets includes determining, by the computer, a solution to an optimization problem defined by at least one dynamic network attribute of the communication network and a weighted sum of the at least one desired QoS attribute of each of the first data packet and the second data packet. An objective function of the optimization problem includes maximizing the probability of satisfying at least one desired QoS attribute of the first data packet. The allocation of the network resources to the logical partition for each data packet of the plurality of data packets further includes allocating, by the computer, the network resources to the logical partition for each of the first data packet and the second data packet, based on the solution to the optimization problem.

In various embodiments of the disclosure, the computer-implemented method further includes monitoring, by the computer, one or more QoS parameters in the network slice. The computer-implemented method further includes altering, by the computer, the network resources for the logical partition of at least one data packet of the plurality of data packets, based on a violation of a threshold condition by the one or more QoS parameters in the network slice.

In various embodiments of the disclosure, the processing application includes one of an edge application of the communication network or a core application of the communication network. At least one edge computing node of the communication network hosts the edge application and at least one cloud computing node of the communication network hosts the core application.

In various embodiments of the disclosure, the sub-slice for each data packet of the plurality of data packets is one of a network sub-slice or an application sub-slice. The network sub-slice supports end-to-end communication between a client device and the at least one cloud computing node of the communication network. The application sub-slice supports end-to-edge communication between the client device and the at least one edge computing node of the communication network.

In various embodiments of the disclosure, a computer system for network slice generation and dynamic adjustment of quality-of-service attributes is described. The computer system includes a processor set, one or more computer-readable storage media, and program instructions stored on the one or more computer-readable storage media. The program instructions are executable by the processor set to cause the processor set to receive a data stream comprising a plurality of data packets. Each data packet of the plurality of data packets comprises a criticality index that indicates a criticality of a processing task associated with a corresponding data packet of the plurality of data packets. The program instructions are executable by the processor set to further cause the processor set to generate a network slice of a communication network for the data stream based on the criticality index of each data packet of the plurality of data packets. The network slice comprises a sub-slice for each data packet of the plurality of data packets. The program instructions are executable by the processor set to further cause the processor set to route each data packet of the plurality of data packets to a processing application of the communication network based on the sub-slice of a corresponding data packet of the plurality of data packets.

In various embodiments of the disclosure, the program instructions further cause the processor set to control a transmitter to transmit each data packet of the plurality of data packets over the sub-slice of a corresponding data packet of the plurality of data packets.

In various embodiments of the disclosure, to generate the network slice for the data stream, the program instructions cause the processor set to create a logical partition of the communication network for each data packet of the plurality of data packets. The program instructions further cause the processor set to determine at least one desired Quality of Service (QoS) attribute for each data packet of the plurality of data packets, based on the criticality index of a corresponding data packet of the plurality of data packets. The program instructions further cause the processor set to allocate network resources to the logical partition for each data packet of the plurality of data packets, based on the at least one desired QoS attribute of a corresponding data packet of the plurality of data packets.

In various embodiments of the disclosure, the plurality of data packets includes a first data packet and a second data packet. The criticality index of the first data packet is higher than the criticality index of the second data packet. To allocate the network resources to the logical partition for each data packet of the plurality of data packets, the program instructions further cause the processor set to determine a solution to an optimization problem defined by at least one dynamic network attribute of the communication network and a weighted sum of the at least one desired QoS attribute of each data packet of the first data packet and the second data packet. An objective function of the optimization problem includes maximization of a probability of satisfaction of the at least one desired QoS attribute of the first data packet. To allocate the network resources to the logical partition for each data packet of the plurality of data packets, the program instructions further cause the processor set to allocate the network resources to the logical partition for each data packet of the first data packet and the second data packet, based on the solution to the optimization problem.

In various embodiments of the disclosure, the program instructions further cause the processor set to monitor one or more Quality of Service (QoS) parameters in the network slice. The program instructions further cause the processor set to alter the network resources for the logical partition of at least one data packet of the plurality of data packets, based on a violation of a threshold condition by the one or more QoS parameters in the network slice.

In various embodiments of the disclosure, the processing application includes one of an edge application of the communication network or a core application of the communication network. At least one edge computing node of the communication network hosts the edge application and at least one cloud computing node of the communication network hosts the core application.

In various embodiments of the disclosure, the sub-slice for each data packet of the plurality of data packets is one of a network sub-slice or an application sub-slice. The network sub-slice supports end-to-end communication between a client device and the at least one cloud computing node of the communication network. The application sub-slice supports end-to-edge communication between the client device and the at least one edge computing node of the communication network.

In various embodiments of the disclosure, a computer-program product for data communication in a communication network is described. The computer program product includes one or more computer-readable storage media and program instructions stored on the one or more computer-readable storage media to perform operations including receiving a data stream comprising a plurality of data packets and obtaining a criticality index for each data packet of the plurality of data packets. The criticality index for each data packet of the plurality of data packets indicates a measure of criticality of a processing task associated with a corresponding data packet of the plurality of data packets. The operations further include generating a network slice of a communication network for the data stream based on the criticality index of each data packet of the plurality of data packets. The network slice comprises a sub-slice for each data packet of the plurality of data packets. The operations further include routing each data packet of the plurality of data packets to a processing application of the communication network based on the sub-slice of a corresponding data packet of the plurality of data packets.

In various embodiments of the disclosure, the operations further include controlling a transmitter to transmit each data packet of the plurality of data packets over the sub-slice of a corresponding data packet of the plurality of data packets.

In various embodiments of the disclosure, for the obtaining of the criticality index for each data packet of the plurality of data packets, the operations include extracting the criticality index of each data packet of the plurality of data packets from a corresponding data packet of the plurality of data packets.

In various embodiments of the disclosure, for the obtaining of the criticality index for each data packet of the plurality of data packets, the operations include receiving the criticality index of each data packet of the plurality of data packets from at least one edge computing node of the communication network. The at least one edge computing node is configured to process each data packet of the plurality of data packets based on a classification engine. The at least one edge computing node is further configured to determine the criticality index for each data packet of the plurality of data packets based on the processing of a corresponding data packet of the plurality of data packets.

In various embodiments of the disclosure, for the generation of the network slice for the data stream, the operations further include creating a logical partition of the communication network for each data packet of the plurality of data packets and determining at least one desired Quality of Service (QoS) attribute for each data packet of the plurality of data packets, based on the criticality index of a corresponding data packet of the plurality of data packets. For the generation of the network slice for the data stream, the operations further include allocating network resources to the logical partition for each data packet of the plurality of data packets, based on the at least one desired QoS attribute of a corresponding data packet of the plurality of data packets.

In various embodiments of the disclosure, the sub-slice for each data packet of the plurality of data packets is one of a network sub-slice or an application sub-slice. The network sub-slice supports end-to-end communication between a client device and the at least one cloud computing node of the communication network. The application sub-slice supports end-to-edge communication between the client device and the at least one edge computing node of the communication network.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the process may be performed in a different order than what is shown in a given flowchart. For example, again depending upon the technology involved, two process shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer process specified in a given CPP claim. A “storage device” is any tangible device that may retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or suitable transmission media. As will be understood by those of skill in the art, data is typically moved at some occasional points in time during the normal process of a storage device, such as during access, de-fragmentation, or garbage collection, but this does not render the storage device as transitory because the data is not transitory while it is stored.

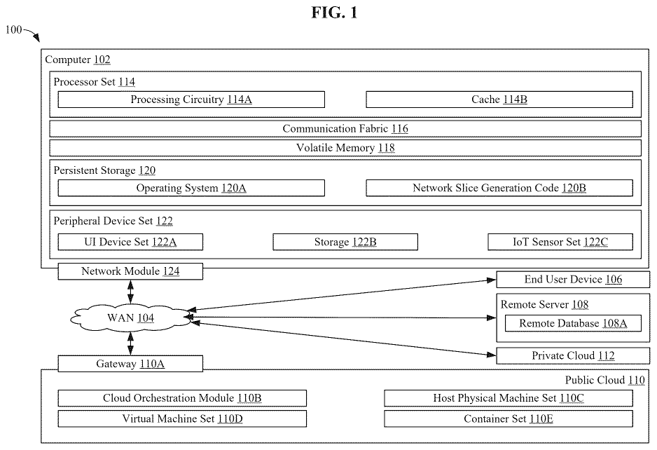

FIG. 1 is a diagram that illustrates a computing environment for network slice generation and dynamic adjustment of quality-of-service attributes in a communication network system, in accordance with an embodiment of the disclosure. With reference to FIG. 1, there is shown a computing environment 100 that contains an example of an environment for the execution of at least some of the computer code involved in performing the disclosed methods, such as a network slice generation code 120B. In addition to the network slice generation code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the network slice generation code 120B as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or suitable wearable computer, a mainframe computer, a quantum computer, or any suitable form of a computer or a mobile device now known or to be developed in the future that can be configured for running a program, accessing a network or querying a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. Alternately the computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computers 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the different storage media discussed below. The program instructions, and associated data, are accessed by the processor set 114 to control and direct the performance of the disclosed methods. In computing environment 100, at least some of the instructions for performing the disclosed methods may be stored in the dynamic modification of the network slice generation code 120B in persistent storage 120.

The communication fabric 116 is the signal conduction path that allows the various components of computer 102 to communicate. Typically, this fabric is made of switches and electrically conductive paths, such as the switches and electrically conductive paths that make up buses, bridges, physical input/output ports, and the like. Additionally, or alternately, any suitable types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the network slice generation associated with the network slice generation code 120B typically includes at least some of the computer code involved in performing the disclosed methods.

The peripheral device set 122 includes the set of peripheral devices of computer 102. Data communication connections between the peripheral devices and the rest of the components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that may be used in Internet of Things applications. For example, a first sensor of the sensors may be a thermometer and a second sensor of the sensors may be a motion detector.

The network module 124 is the collection of computer software, hardware, and firmware that allows computer 102 to communicate with external computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to computer 102 from an external computer or external storage device through a network adapter card or network interface included in the network module 124.

The WAN 104 is any wide area network (for example, the internet) that communicates computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation may typically be communicated from the network module 124 of computer 102 through WAN 104 to EUD 106. In this way, the EUD 106 may display, or present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machines that collect and store helpful and useful data for use by computing systems, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or computation abilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize all resources of that computer, such as connected devices, files and folders, network shares, CPU power, and quantifiable hardware resources. However, programs running inside a container may only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

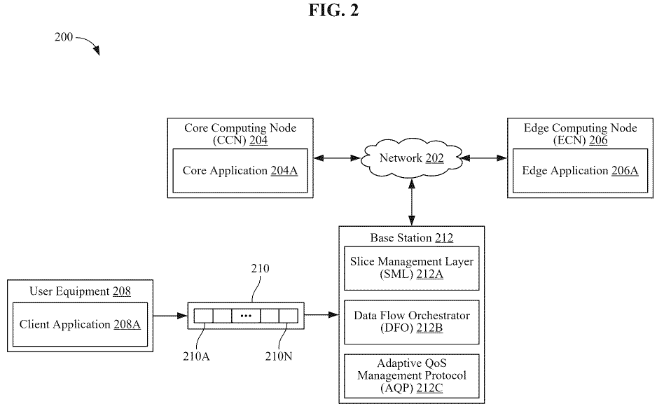

FIG. 2 is a diagram that illustrates a system 200 for network slice generation and dynamic adjustment of quality-of-service attributes, in accordance with an embodiment of the disclosure. FIG. 2 is explained in conjunction with elements from FIG. 1. The system 200 includes a network 202 communicatively coupled to user equipment 208, a base station 212, an edge computing node (ECN) 206, and a core computing node (CCN) 204. The data stream 210 originating from the client application 208A on the user equipment 208 consists of multiple data packets 210A, which are processed and routed dynamically based on predefined conditions.

User equipment 208 may serve as the originating or receiving point of the data stream 210. The user equipment 208 includes one or more client devices such as smartphones, tablets, IoT sensors, autonomous vehicles, smart home devices, industrial machinery, and wearable devices. The devices run client applications 208A, which generate, transmit, or receive data packets 210A depending on the specific use case. For example, in a smart healthcare scenario, a wearable medical device monitoring a patient's vitals continuously generates data packets containing real-time heart rate, oxygen levels, or ECG readings, which are transmitted through the communication network for processing. Similarly, in an industrial IoT setup, factory sensors transmit operational data to optimize machinery performance, detect faults, and ensure predictive maintenance.

The data stream 210 represents the continuous flow of information transmitted through the network 202. The data stream 210 includes a plurality of data packets 210A to 210N, which are discrete units of data carrying information between different components in the system 200. The plurality of data packets 210A-210N may originate from one or more applications running on the user equipment (UE) 208. One example of such an application may be a client application 208A. Each data packet of the plurality of data packets 210A-210N contains payload data, metadata, and network headers which help determine how each data packet of the plurality of data packets is to be handled. The size of each data packet of the plurality of data packets may vary based on the application and network protocol, typically ranging from a few bytes (for control signals in IoT devices) to several megabytes (for high-resolution video frames in streaming applications). Each data packet of the plurality of data packets 210A-210N may follow different routing paths depending on network conditions, device priority, and QoS needs.

The plurality of data packets 210A-210N may be categorized based on their processing and transmission requirements. Some data packets may require low latency (such as emergency response signals or financial transactions), while some data packets may demand high bandwidth (such as real-time video conferencing or virtual reality applications). Certain data packets may be delay-tolerant, such as software updates or email synchronization, allowing the data packets to be processed at a later time without impacting service quality.

When the data stream 210 reaches the base station 212, the slice management layer (SML) 212A identifies the QoS needs of each packet of the plurality of data packets 210A and assigns each packet of the plurality of data packets 210A to appropriate network slices. The data flow orchestrator (DFO) 212B determines whether the data packet is to be processed at the ECN 206 or is to be sent to the core computing node or the CCN 204, depending on its processing complexity and latency requirements. The adaptive QoS management protocol (AQP) 212C monitors packet delivery performance and adjusts network resources dynamically to meet service requirements.

The edge computing node (ECN) 206 is a distributed computing resource located closer to user equipment (UE) 208 than the CCN 204, often at base stations, access points, or dedicated edge servers. The ECN may be configured to process latency-sensitive tasks required for real-time computation. Instead of sending data to the CCN 204, which may introduce transmission delays, the ECN 206 may execute tasks locally to enhance responsiveness. The ECN 206 may handle data communication with multiple real-time applications. When a data packet arrives at the base station 212, the slice management layer (SML) 212A and data flow orchestrator (DFO) 212B determine if the data packet or data packet 210A requires low latency. If the outcome of such a determination is yes, the AQP 212C assigns the task to the ECN 206.

For example, in autonomous driving applications, an ECN 206 near a traffic intersection processes real-time sensor data to detect pedestrians and vehicles, enabling immediate decision-making. Similarly, in telemedicine, real-time patient monitoring and emergency alert systems rely on edge computing to provide rapid responses without delays.

The CCN 204 serves as a centralized processing hub with extensive computational resources. Unlike the ECN 206 which prioritizes real-time processing, the CCN 204 may be configured for handling computationally intensive and less time-sensitive tasks, such as machine learning model training tasks, big data analytics, and cloud-based simulations. Data packets requiring high processing power may be routed to the CCN 204 through the SML 212A and the DFO 212B. This allows large-scale computations to be executed efficiently while freeing up edge resources for real-time applications.

For example, in predictive maintenance for industrial equipment, sensor data from multiple machines may be periodically sent to the CCN 204 for analysis, where the CCN 204 may run one or more artificial intelligence (AI) models to predict failures and optimize maintenance schedules. In video streaming applications, content caching and encoding are managed in the CCN 204 to provide scalable and efficient distribution.

As an example, in an autonomous vehicle system, a Light Detection and Ranging (LiDAR) may produce a data stream that includes real-time control packets as well as data packets pertaining to the historical driving pattern of the vehicle. The real-time control packets may require immediate processing at the ECN 206, ensuring fast decision-making for obstacle detection while the historical driving pattern data packets may be sent to the CCN 204 for long-term analytics and model training. Similarly, in smart healthcare applications, patient vitals data packets from a wearable device may require real-time monitoring at the ECN 206, whereas periodic health report data packets may be processed at the CCN 204 for centralized medical analysis.

The base station 212 serves as an intermediary node between the user equipment 208 and the various applications in the system 200. For example, the base station 212 is the primary access point between user equipment (UE) 208 and the network 202. The base station 212 receives data packets from the data stream 210, analyses their requirements, and makes intelligent decisions regarding network slicing, resource allocation, and data routing. The base station 212 includes multiple functional components ensuring efficient network management. In this regard, the base station 212 includes the SML 212A, the DFO 212B, and the AQP 212C.

The SML 212A manages the generation, utilization, and modification of network slices of network 202. The network slices are logical partitions of the network 202 designed to meet specific QoS requirements. The SML 212A assigns each data packet of the plurality of data packets 210A-210N to an appropriate network slice based on its priority, application type, and processing needs. For instance, in an autonomous vehicle system, control signals for braking and acceleration require ultra-low latency and may be assigned to a dedicated low-latency slice, while infotainment data (such as media streaming) may be assigned to a high-bandwidth but non-time-sensitive slice. The SML 212A dynamically adjusts slices based on real-time network conditions, ensuring performance across different applications.

The DFO 212B directs the flow of data packets within the network 202. The DFO determines whether a data packet is to be processed at the ECN 206 for real-time applications or sent to the CCN 204 for more extensive processing. The DFO 212B takes into account network congestion, available computing resources, and QoS parameters while making routing decisions. For example, in an industrial automation scenario, real-time sensor data for robotic control is immediately processed at the edge for minimal latency, while bulk analytical data related to machine performance trends is transmitted to the core network for long-term processing and optimization.

The AQP 212C monitors network conditions and dynamically adjusts QoS attributes to maintain service levels. The AQP ensures the data packets meet their required latency, bandwidth, and reliability constraints by dynamically reallocating network resources. For instance, if an ongoing remote surgery session experiences network congestion, AQP prioritizes the surgical control signals by reallocating bandwidth from lower-priority applications, such as background file transfers. Similarly, in a smart city traffic management system, AQP ensures the emergency vehicle communication receives higher priority than routine surveillance footage.

The network 202 serves as the communication backbone of the system 200, facilitating seamless data exchange between user equipment (UE) 208, the base station (BS) 212, the edge computing node (ECN) 206, and the CCN 204. The CCN 204 is designed to support a diverse range of applications, each with distinct quality of service (QoS) requirements, by leveraging network slicing, edge computing, and adaptive resource allocation. The network 202 may be implemented using multiple communication technologies to provide efficient data transmission across different network segments. Wired connections, such as fiber optics and Ethernet, provide high-speed, low-latency links between the core network and data centers, ensuring reliable connectivity for cloud-based processing at the CCN. Wireless technologies, including 5G, Wi-Fi 6, LoRaWAN, and satellite communication, offer flexible and scalable solutions for real-time applications, enabling connectivity for mobile devices, IoT sensors, and autonomous systems. In a 5G-enabled environment, network slicing allows the creation of customized virtual networks, each optimized for specific use cases. For instance, a low-latency, ultra-reliable slice may support autonomous vehicle communication, while a high-bandwidth slice may be allocated for high-definition video streaming. The SML 212A and AQP 212C dynamically adjust network resources to maintain performance within the defined QoS parameters. For mission-critical applications, such as real-time healthcare monitoring and industrial automation, the network 202 provides low-latency edge processing by routing computational tasks to the ECN 206 instead of the CCN 204. This reduces transmission delays and enhances responsiveness. Conversely, for computationally intensive tasks, the network 202 offloads processing to the CCN 204, leveraging cloud-scale resources. To maintain secure and efficient data transmission, the network 202 may integrate virtual private networks (VPNs), blockchain technology, and internet of Things (IoT) protocols such as Message Queue Telemetry Transport (MQTT) protocol and Constrained Application Protocol (CoAP). In scenarios requiring high-precision localization, such as smart factories or automated logistics, Ultra-Wideband (UWB) technology may be used for accurate tracking and coordination.

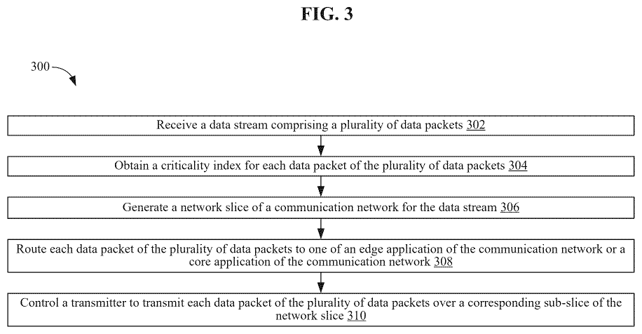

FIG. 3 is a diagram that illustrates a flowchart an exemplary method for network slice generation and dynamic adjustment of quality-of-service attributes, in accordance with an embodiment of the disclosure. FIG. 3 is explained in conjunction with elements from FIGS. 1 and 2. With reference to FIG. 3 there is shown a method 300 for network slice generation and dynamic adjustment of quality-of-service attributes that illustrates exemplary operations from 302-310, as described herein.

The method 300 includes at 302, operations for receiving a data stream comprising a plurality of data packets. The data stream originates from various applications that require distinct levels of network performance, such as real-time healthcare monitoring, autonomous vehicle communication, and high-definition video streaming. The data stream comprises a plurality of data packets, originating from various sources such as IoT devices in industrial automation, autonomous vehicles for real-time navigation, healthcare applications including remote monitoring, and multimedia services such as HD video streaming and virtual reality. Each data packet of the plurality of data packets varies in size, priority, and processing requirements, ranging from small packets of 64-512 bytes for sensor networks to large packets of several megabytes for AI-driven applications. Given the diverse nature of these applications, the system 200 may first process the incoming data stream to determine the unique requirements of each data packet of the plurality of data packets.

The method 300 also includes at 304, operations for obtaining a criticality index for each data packet of the plurality of data packets. The criticality index of a data packet may be utilized by the system 200 to determine the priority and the necessary network resources (i.e., bandwidth allocation, latency control, computational power, network slicing, reliability mechanisms, and jitter control) required for transmission of that data packet. In this regard, the system 200 may classify each data packet of the plurality of data packets based on the criticality index of a corresponding data packet of the plurality of data packets. Towards this end, the system 200 may compare the criticality index of a data packet with at least one criticality threshold to classify the data packet into a criticality class of a plurality of criticality classes. According to one embodiment, the criticality index of each data packet may be assigned by a source application or device that generates the corresponding data packet. For example, a source application or device may assign a criticality index higher than a threshold value if the data packet is associated with a time-sensitive task of the source application. As another example, if a source application requires a data packet to be processed externally after transmission, the source application may assign to that data packet, a criticality index higher than that of a data packet which does not require external processing after transmission. In an alternate embodiment, the system 200 may compute the criticality index of each data packet based on one or multiple QoS attributes including latency, jitter, bandwidth, reliability, and packet loss rate. The system 200 may assign a criticality score to each data packet of the plurality of data packets based on predefined thresholds and historical network conditions, which may be derived from machine learning models, policy-based frameworks, or real-time network monitoring. For instance, in a healthcare monitoring system, real-time control signals for robotic surgery and continuous patient vitals demand ultra-low latency (1-10 ms) and high reliability for immediate response and precise execution. In contrast, periodic patient records or non-urgent updates, such as historical medical data uploads, may tolerate higher latency and lower bandwidth. Additionally, the criticality score may be influenced by factors such as the application type, user-defined service level agreements (SLAs), current network congestion levels, and environmental conditions. For example, in an industrial IoT setup, a sensor reporting a critical machine fault may be assigned a higher criticality score compared to routine maintenance logs. Similarly, in autonomous driving, data packets containing collision alerts may be prioritized over infotainment data. The system 200 may also consider temporal variations, such as peak-hour traffic conditions or emergencies, dynamically adjusting the criticality index for resource allocation.

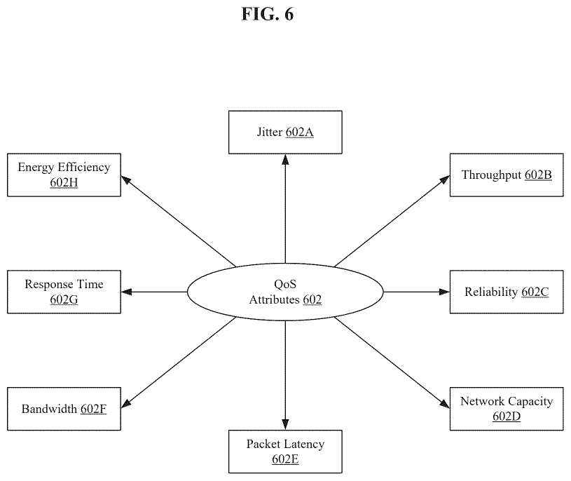

The method 300 also includes at 306, operations for generating a network slice of a communication network for the data stream. The system 200 analyses the classified data packets and groups the classified data packets based on their QoS requirements (explained in detail in FIG. 6). The system 200 creates logical partitions, each designed to handle different types of traffic. For example, the system 200 assigns a low-latency, high-priority sub-slice for mission-critical healthcare applications, a high-bandwidth sub-slice for real-time high-definition video streaming, and a best-effort sub-slice for background data transmission. The system 200 dynamically allocates network resources to the logical partition for each data packet of the plurality of data packets based on real-time traffic demands. A network slice is a logical partition of the communication network that provides customized network performance tailored to the requirements of the classified data packets. The system 200 may utilize 5G network slicing technology to create a plurality of sub-slices or logical partitions, each optimized for different QoS needs.

The method 300 also includes at 308, operations for routing each data packet of the plurality of data packets to one of an edge application of the communication network or a core application of the communication network. The system 200 utilizes a dual-layer slicing approach, where each data packet of the plurality of data packets is assigned to a specific sub-slice based on its processing and latency requirements. Each sub-slice of plurality of sub-slices falls into one of two categories: an edge application or a core application. The core application provides end-to-end communication between a client device and the cloud computing node, enabling centralized processing for tasks that require extensive computational power but are less latency-sensitive. The edge application facilitates end-to-edge communication between the client device and an edge computing node, ensuring ultra-low-latency processing for time-sensitive applications.

For example, real-time applications such as AI-based medical diagnostics, autonomous emergency response, or industrial automation require immediate processing and are assigned to an edge application, ensuring minimal delay. Meanwhile, tasks such as predictive analytics or historical data processing, which are less time-sensitive, are routed through a cloud application to utilize centralized cloud computing resources.

The method 300 also includes at 310, operations for controlling a transmitter to transmit each data packet of the plurality of the data packets over a corresponding sub-slice of the generated network slice. By dynamically assigning the data packets to sub-slices based on their QoS requirements, the system 200 guarantees the data packets are delivered with guaranteed latency, bandwidth, and reliability. Additionally, the network 202 optimizes bandwidth allocation to maintain high throughput for HD video and telemetry, latency prioritization for real-time control, and packet scheduling policies to minimize jitter and packet loss.

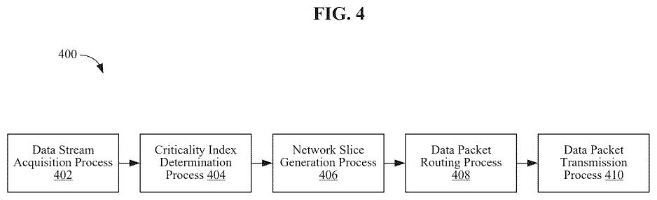

FIG. 4 is a diagram that illustrates an exemplary framework 400 for network slice generation and dynamic adjustment of quality-of-service attributes, in accordance with an embodiment of the disclosure. FIG. 4 is explained in conjunction with elements from FIG. 1 and FIG. 2. The exemplary framework 400 includes operations or processes for data stream acquisition, criticality index determination, network slice generation, data packet routing, and data packet transmission. The processes depicted in FIG. 4 represent one possible implementation of the exemplary framework 400, but additional or fewer processes may be incorporated depending on system 200 requirements and operational constraints. The exemplary framework 400 may function as a dynamic workflow executed by the system 200 of FIG. 2, either on demand or through automated triggers based on real-time events. In the context of network resource allocation and QoS-based optimization, the system 200 may analyze the incoming data stream to determine whether tasks are processed at the edge computing node (ECN) or the core computing node (CCN) based on their computational complexity and latency requirements.

The exemplary framework 400 for the network slice generation includes a data stream acquisition process 402 as a part of which, the system 200 receives a continuous data stream from various sources, such as user devices, IoT devices, autonomous systems, and real-time monitoring applications. The incoming data stream comprises a plurality of data packets, each comprising different or various types of information, such as sensor readings, multimedia content, control signals, or transactional data. Each data packet of the plurality of data packets may vary in size, format, and transmission urgency, depending on their source and purpose. The system 200 captures the data packets in real-time or near real-time using high-speed wired or wireless communication protocols, such as 5G, Wi-Fi, or satellite networks, to support diverse application requirements.

The exemplary framework 400 for the network slice generation also includes a criticality index determination process 404. In the criticality index determination process 404, the system 200 may assign a criticality score to each data packet of the plurality of data packets based on its importance and network constraints. The system 200 extracts the criticality index from the data packet itself or derives the criticality index from the edge computing node (ECN) 206. The ECN 206 may compute the criticality index of each data packet of the plurality of data packets using machine learning models, policy-based frameworks, or real-time network monitoring. In an embodiment, the ECN 206 processes each data packet of the plurality of data packets using a classification engine and determines the criticality index based on factors such as latency, jitter, bandwidth, reliability, and packet loss rate. For instance, in a smart healthcare application, real-time patient vitals and robotic surgery control signals require ultra-low latency and high reliability, whereas periodic updates or background data transfers may tolerate higher latency. Based on the assigned criticality index, the system 200 allocates network resources accordingly, ensuring the high-priority data is transmitted with minimal delay while optimizing resource utilization for lower-priority traffic.

The criticality index of each data packet of the plurality of data packets may be computed or assigned in multiple ways. Broadly, each data packet of the plurality of data packets may be classified as either critical or non-critical. Critical data packets are those that require prioritized network resources, while non-critical data packets may tolerate delays without significant impact. Within the critical category, further subdivisions may be made based on urgency. Ultra-critical data packets such as those associated with robotic surgery commands or emergency alerts in a smart healthcare system, may demand immediate transmission with minimal delay. Moderate-critical data packets such as those associated with real-time video conferencing or remote industrial monitoring, may require high reliability but may withstand slight delays. Low-critical data packets, such as those associated with periodic system health updates in a smart factory, may still require prioritized handling but have more flexibility. Non-critical data packets include background data transfers, software updates, or bulk file transmissions that may not require immediate network allocation.

The exemplary framework 400 for the network slice generation also includes a network slice generation process 406. In the network slice generation process 406, the system 200 creates a logical partition of the communication network for each data packet of the plurality of data packets, ensuring that different QoS requirements are handled separately. The system 200 determines the desired QoS attributes for each data packet of the plurality of data packets based on its criticality index and allocates network resources accordingly. High-priority data packets are given higher bandwidth and lower latency paths, while lower-priority packets are routed through best-effort channels. The system 200 solves an optimization problem by considering dynamic network conditions and the weighted sum of QoS attributes for different packets, ensuring the most critical data packets receive guaranteed performance. The slicing process supports both network sub-slices and application sub-slices. Network sub-slices facilitate end-to-end communication between the user equipment 208 and the CCN 204, while application sub-slices provide end-to-edge communication between the user equipment 208 (or a client device) and the ECN 206.

The exemplary framework 400 for the network slice generation also includes a data packet routing process 408. In the data packet routing process 408, the system 200 determines whether each data packet of the plurality of data packets should be processed at the ECN 206 or the CCN 204. The DFO 212B dynamically directs traffic based on the latency requirements and computational needs of each data packet of the plurality of data packets. Mission-critical applications such as AI-driven emergency response or autonomous vehicle control are processed at the ECN 206 to minimize transmission delays, whereas applications requiring heavy computation but not real-time constraints, such as batch processing or predictive analytics, are routed to the CCN 204 for cloud-based processing.

The exemplary framework 400 for the network slice generation also includes a data packet transmission process 410. In the data packet transmission process 410, the system 200 controls a transmitter to send each data packet of the plurality of data packets over a corresponding sub-slice of the allocated network slice. The system 200 determines the appropriate sub-slice based on QoS attributes such as latency, jitter, and throughput, ensuring the data packets are transmitted under certain conditions. Data packets requiring low latency may be transmitted over a high-priority sub-slice, while non-critical packets may be routed through a best-effort sub-slice. The system 200 continuously monitors network slice performance and dynamically reallocates resources if a QoS threshold is violated. Traffic prioritization techniques, congestion control mechanisms, and redundancy protocols ensure reliability. If a bottleneck is detected, the system 200 adjusts bandwidth allocation, modifies scheduling policies, or redistributes computing resources within the logical partition.

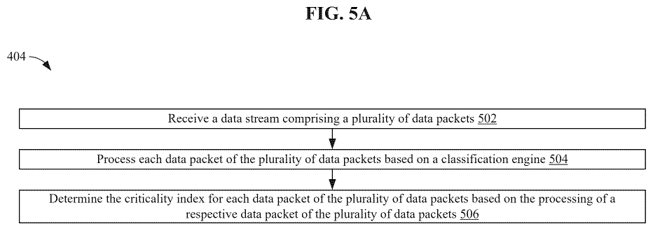

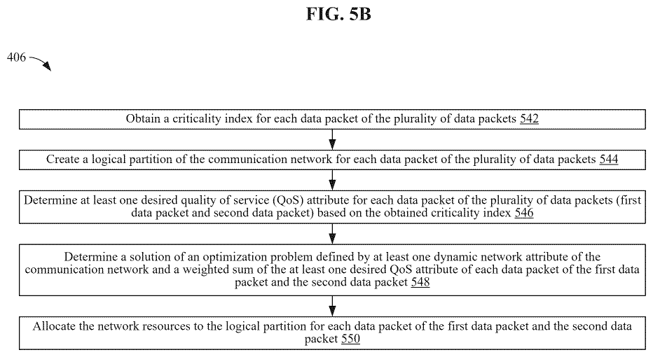

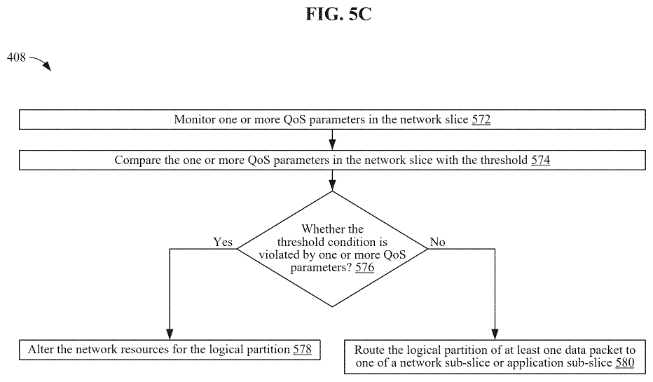

FIG. 5A is a diagram that illustrates a flowchart of the criticality index determination process 404 of the exemplary framework 400 of FIG. 4, in accordance with an embodiment of the disclosure. FIG. 5A is explained in conjunction with elements from FIGS. 1-4. With reference to FIG. 5A, the criticality index determination process 404 comprises exemplary operations from 502-506, as described herein. The exemplary operations illustrated in the block diagram of the criticality index determination process 404 may be performed by any system, apparatus, or device. Although illustrated with discrete blocks, the exemplary operations associated with one or more blocks of the criticality index determination process 404 may be divided into additional blocks, combined into fewer blocks, or eliminated, depending on the particular implementation.

The criticality index determination process 404 includes an operation 502 for receiving a data stream comprising a plurality of data packets. The data packets originate from various sources such as user equipment (UE), IoT devices, cloud applications, or autonomous systems. The data stream may contain a mix of real-time communication packets, high-bandwidth multimedia data, transactional requests, and background synchronization packets. The incoming data packets may arrive through multiple network interfaces, including 5G cellular networks, Wi-Fi, satellite links, or wired Ethernet connections.

The criticality index determination process 404 further includes an operation 504 for processing each data packet of the plurality of data packets based on a classification engine. The ECN 206 processes each data packet of the plurality of data packets using a classification engine. The ECN 206 analyses metadata including packet type, source, destination, application type, and network conditions, as well as factors such as real-time network congestion and QoS attributes associated with a data packet to determine the data packet's urgency. In an embodiment, a classification engine may process a data packet to evaluate the latency sensitivity of the data packet. For example, the classification engine evaluates the latency sensitivity of the data packet by assessing timestamp information associated with the data packet and bandwidth requirements of the data packet. Additionally, the classification engine considers congestion status by monitoring network buffer occupancy and transmission delays. The classification engine may use machine learning models, rule-based filtering, deep packet inspection (DPI), or AI-driven traffic analysis to categorize the plurality of data packets. For example, the ECN 206 may invoke a classification engine to process the information indicated in the application type field of the metadata of a data packet to determine whether the data packet belongs to a real-time communication session, a latency-sensitive industrial control system, or general background traffic.

The criticality index determination process 404 further includes an operation 506 for determining the criticality index for each data packet of the plurality of data packets based on the processing of a respective data packet of the plurality of data packets. The ECN 206 determines the criticality index of each data packet of the plurality of data packets based on the classification results. The classification engine assigns a numerical or categorical priority score to each data packet of the plurality of data packets based on the result of the processing at operation 504. The numerical index may be derived using a predefined formula or an AI-based decision model that weighs factors such as jitter tolerance, loss sensitivity, and service-level agreements. For instance, a command packet for remote robotic surgery may be assigned the highest criticality index due to its strict latency and reliability requirements. In contrast, a video streaming packet may be given a lower priority, since minor buffering may not significantly impact user experience. Referring to the example considered in operation 504, where the data packet is determined to be belonging to a real-time communication session, the ECN 206 may assign a criticality index higher than a first threshold. However, where the data packet is determined to be belonging to a latency-sensitive industrial control system, the ECN 206 may assign a criticality index lower than the first threshold but higher than a second threshold. However, where the data packet is determined to be belonging to general background traffic, the ECN 206 may assign a criticality index lower than the second threshold.

In an embodiment, the criticality index of a data packet may be a numerical value that represents the priority of the data packet for transmission. In an embodiment, the criticality index of each data packet may be computed by a source application that generates the data packet or by a device that transmits the data packet to the system 200 or the ECN 206. In such scenarios, the system 200 or the ECN 206, as the case may be, may extract the criticality index of each data packet of the plurality of data packets from the corresponding data packet of the plurality of data packets. In such cases, the criticality index may be embedded directly within the data packet's metadata, allowing all downstream network components, such as base stations, core network nodes, and cloud computing resources, to recognize and process the data packet according to its assigned priority/criticality. Routers, base stations, cloud computing nodes, and service orchestration platforms retrieve the criticality index embedded within the metadata of each data packet. The extraction involves parsing the data packet header or payload. In core network nodes, deep packet inspection (DPI) techniques may be used to analyze the data packet headers and retrieve the criticality index of the corresponding data packet. optimize network slice resource allocation. The ECN 206 sends the criticality index alongside the data packet, ensuring that network components process data packets based on priority.

FIG. 5B is a diagram that illustrates a flowchart of the network slice generation process 406 of the exemplary framework 400 of FIG. 4, in accordance with an embodiment of the disclosure. FIG. 5B is explained in conjunction with elements from FIGS. 1-4. With reference to FIG. 5B, the network slice generation process 406 includes operations from 542-550, as described herein. The exemplary operations illustrated in the block diagram of network slice generation process 406 may be performed by any system, apparatus, or device. Although illustrated with discrete blocks, the exemplary operations associated with one or more blocks of the network slice generation process 406 may be divided into additional blocks, combined into fewer blocks, or eliminated, depending on the particular implementation. In an embodiment, the network slice generation process 406 may be executed by the base station 212 (also referred to as core network). The base station 212 or the core network receives the criticality index and allocates network resources dynamically. The base station 212 adjusts radio spectrum allocation, schedules transmissions, and provisions bandwidth according to the data packet's criticality. In cases where multiple data packets compete for resources, the base station 212 prioritizes high-criticality packets, ensuring the latency-sensitive applications receive preferential treatment. For example, in a 5G ultra-reliable low-latency communication (URLLC) scenario, data packets with high criticality indices, such as those from autonomous vehicle control systems or remote robotic surgery, are assigned to specialized network slices. The slices guarantee ultra-low latency and high reliability, ensuring that mission-critical operations are executed without delays or interruptions. Meanwhile, data packets with lower criticality, such as background synchronization data or telemetry updates, are routed through standard network slices, preventing resource congestion in high-priority channels.

The network slice generation process 406 includes an operation 542 for obtaining a criticality index for each data packet of the plurality of data packets. The criticality index is derived based on factors such as latency sensitivity, bandwidth requirements, and reliability needs. The criticality index may be determined at the edge computing node (ECN) or extracted from the data packet metadata in the manner described with respect to FIG. 5A, allowing the network to prioritize the data packets accordingly.

The network slice generation process 406 also includes an operation 544 for creating a logical partition of the communication network for each data packet of the plurality of data packets. The SML 212A of the base station 212 may execute the partitioning process. The SML 212A dynamically generates a plurality of sub-slices (also referred to as logical partitions) by evaluating the criticality index assigned to each data packet of the plurality of data packets and mapping to predefined network slice configurations. The sub-slices ensure the data packets with similar QoS requirements are processed together, preventing interference from lower-priority traffic.

The creation of the sub-slices involves resource segmentation at multiple levels, including radio access, transport, and core network layers. The base station assigns dedicated frequency bands, time slots, or virtualized network functions to each sub-slice of the plurality of sub-slices. For example, in a 5G network, a sub-slice for ultra-reliable low-latency communication (URLLC) may be provisioned with low-latency transmission slots, while an enhanced mobile broadband (eMBB) sub-slice receives higher bandwidth for data-intensive applications. The network orchestrator, often integrated with the SML 212A and data flow orchestrator (DFO) 212B, continuously monitors real-time network conditions and dynamically adjusts sub-slice parameters. If the network detects congestion or shifting traffic demands, it may reallocate resources between sub-slices. For instance, in an autonomous vehicle network, an emergency braking signal is prioritized over background infotainment streaming by dynamically adjusting bandwidth allocation within the URLLC sub-slice.

The network slice generation process 406 further includes an operation 546 for determining at least one desired quality of service (QoS) attribute for each data packet of the plurality of data packets (for example a first data packet and a second data packet) based on the obtained criticality index. The determination involves analyzing the criticality index assigned to the data packet and mapping to predefined QoS parameters (explained in detail with reference to FIG. 6) such as latency, jitter, throughput, and packet loss tolerance. The classification engine, either at the edge computing node (ECN) or a network controller, processes the criticality index and cross-references the data packets with QoS requirement databases or predefined policies. For example, if a data packet belongs to an application requiring ultra-reliable low-latency communication (URLLC), such as remote robotic surgery, the system 200 assigns the data packet the stringent QoS attributes of low latency (e.g., below 1 ms), minimal jitter, and near-zero packet loss. Conversely, if the data packet corresponds to a best-effort application such as cloud data synchronization, the system 200 allows higher latency and packet loss. The system 200 processes a plurality of data packets, each with an assigned criticality index. For example, if among a first data packet and a second data packet, the first data packet has a higher criticality index and the second data packet has a lower criticality index, the system 200 considers the differences in priority to optimize resource allocation. The system 200 identifies the criticality index of each data packet of the plurality of data packets to differentiate its handling. Since the first data packet has a higher criticality index, it requires preferential resource allocation over the second data packet.

The network slice generation process 406 further includes an operation 548 for determining a solution to an optimization problem defined by at least one dynamic network attribute of the communication network and a weighted sum of the at least one desired QoS attribute of each data packet of the first data packet and the second data packet. The optimization considers factors such as network congestion, available bandwidth, transmission delays, and overall traffic load. The optimization aims to maximize the probability of meeting the required QoS attributes while ensuring efficient resource utilization. The optimization process involves assigning weights to different QoS attributes, such as latency, jitter, and packet loss tolerance, based on the criticality index of each data packet of the plurality of data packets. For instance, if a first data packet has a higher criticality index than a second data packet, the system 200 assigns a greater weight to parameters such as latency and reliability, ensuring the first data packet is prioritized in network resource allocation. The weighted sum technique helps a trade-off between competing QoS requirements, ensuring that high-priority traffic receives adequate resources without significantly degrading the performance of lower-priority packets. To solve the optimization problem, the system 200 may use mathematical models such as linear programming, machine learning-based predictive algorithms or heuristic-based approaches. These methods analyze the state of the communication network and adapt to changing conditions.

The network slice generation process 406 further includes operation 550 for allocating the network resources to the logical partition for each data packet of the first data packet and the second data packet. Network resources refer to various elements that facilitate data transmission and communication, including bandwidth, transmission scheduling, routing paths, processing power, and radio spectrum. The system 200 allocates network resources to the logical partition by dynamically adjusting bandwidth, transmission scheduling, and routing based on the criticality index and QoS requirements. The base station or network orchestrator assigns radio spectrum, prioritizes transmission slots, and configures routing paths for packet delivery. In a 5G network, if the first data packet has a higher criticality index, the system 200 may allocate the first data packet to a dedicated URLLC slice, for ultra-low latency and high reliability. The base station reserves specific time slots for transmission using mechanisms such as grant-free scheduling or pre-emptive resource allocation. In contrast, a lower-priority packet may be routed through an enhanced mobile broadband (eMBB) slice with best-effort delivery.

FIG. 5C is a diagram that illustrates a flowchart of the data packet routing process 408 of the exemplary framework 400 of FIG. 4, in accordance with an embodiment of the disclosure. FIG. 5C is explained in conjunction with elements from FIGS. 1-4 and 2. With reference to FIG. 5C, the data packet routing process 408 includes exemplary operations from 572-578, as described herein. The exemplary operations illustrated in the block diagram of the data packet routing process 408 may be performed by any system, apparatus, or device. Although illustrated with discrete blocks, the exemplary operations associated with one or more blocks of the data packet routing process 408 may be divided into additional blocks, combined into fewer blocks, or eliminated, depending on the particular implementation.

The data packet routing process 408 includes an operation 572 for monitoring one or more QoS parameters in the network slice. This involves continuous observation and measurement of QoS parameters such as latency, jitter, packet loss, and throughput for network performance that remains within acceptable limits. The system 200 allocates the network resources based on the criticality index of data packets, and the system 200 monitors by collecting real-time performance data from base stations, edge computing nodes, and core network components. For instance, in a 5G network, monitoring verifies a slice assigned to low-latency applications, such as autonomous vehicles, and maintains its required performance levels.

The data packet routing process 408 includes an operation 574 for comparing one or more QoS parameters in the network slice with the threshold. The system 200 compares the monitored QoS parameters with predefined or dynamically allocated threshold values to determine whether network performance remains within acceptable limits. The thresholds may be static, meaning they are set in advance based on expected network conditions, or dynamic, meaning they adjust in real-time based on observed network behavior and demand patterns. For instance, a static threshold for latency in a 5G URLLC slice may be predefined at 1 ms, whereas a dynamic threshold may vary based on congestion levels, adjusting between 0.8 ms to 1.2 ms depending on real-time network traffic. The comparison process involves real-time analysis of performance data collected from telemetry systems, routers, and servers. The system 200 continuously gathers QoS metrics, such as latency (delay in data transmission), jitter (variability in packet delay), packet loss (percentage of lost packets), and throughput (data transfer rate). The collected data is processed through a network monitoring engine, which evaluates whether any metric satisfies its threshold.

The data packet routing process 408 includes an operation 576 for checking whether the threshold condition is violated by one or more QoS parameters. If all QoS parameters remain within acceptable ranges, no action may be required, and the system 200 continues to the operation 580 for routing the logical partition of at least one data packet to one of a network sub-slice or application sub-slice. However, if a threshold violation is detected, the system 200 processes operation 578 for altering the network resources allocated to the logical partition. The system 200 dynamically reallocates network resources such as bandwidth, adjusts scheduling policies, or modifies transmission priorities to restore QoS levels. This may involve shifting resources from lower-priority slices for uninterrupted performance for high-priority applications. The threshold values may be predefined based on the application's QoS requirements. For example, in a smart factory, robotic control systems may require latency to remain below 5 ms for seamless operation. If monitoring detects a spike beyond 10 ms, the system 200 identifies it as a threshold violation and prepares to adjust network resources. Similarly, for URLLC applications in 5G networks, latency thresholds are often set below 1 ms, and if the system 200 detects a delay of 3 ms, it reallocates bandwidth or modifies scheduling policies to restore performance.

FIG. 6 is a diagram that illustrates some examples of QoS attributes 602 associated with data communication in a network, in accordance with an embodiment of the disclosure. FIG. 6 is explained in conjunction with elements from FIGS. 1-5C. The QoS attributes 602 manage ensuring efficient data transmission, resource allocation, and reliable communication across different network slices. In this system 200, the QoS attributes 602 influence network slicing and resource allocation. The system 200 uses the QoS attributes 602 to adjust network slicing. If a high-priority data stream requires low latency (e.g., below 1 ms for time-sensitive operations), the system 200 assigns the data stream to a specialized network slice with dedicated resources. Applications that tolerate some delay, such as file transfers or non-urgent telemetry data, are placed in slices with flexible bandwidth allocation.

The QoS attributes 602 may include jitter 602A, throughput 602B, reliability 602C, network capacity 602D, packet latency 602E, bandwidth 602F, response time 602G, and energy efficiency 602H. The jitter 602A as a QoS attribute refers to the variation in data packet arrival times across the network. When data packets arrive at irregular intervals due to fluctuating delays, it leads to poor performance in real-time applications. High jitter may cause disruptions in real-time applications such as video calls, VoIP communication, and industrial automation. For example, in a remote robotic surgery system, jitter 602A exceeding 10 milliseconds may cause delays in instrument movements, potentially affecting surgical precision. To control the jitter 602A, the system 200 employs buffering techniques, prioritizes real-time packets, and provides stable routing paths. A high value of the jitter 602A may require adjusting transmission schedules or reassigning network resources to maintain stable data flow.

Throughput 602B as a QoS attribute measures the rate at which data packets are successfully transmitted over the network, typically expressed in Mbps or Gbps. Higher throughput 602B affirms smooth streaming, cloud storage operations, and AI-driven data processing. However, throughput 602B may be affected by factors such as network congestion, interference, and hardware limitations. If throughput 602B falls below the required level, data-intensive applications such as 8K video streaming may experience buffering, while real-time analytics in smart grids may suffer delays in energy distribution adjustments. For instance, in a smart factory deploying AI-based quality control, the throughput 602B is needed to transmit real-time camera feeds for defect detection. If throughput 602B is insufficient, the system 200 may experience processing delays, reducing operational efficiency. The system 200 dynamically adjusts throughput by reallocating bandwidth and optimizing routing paths.

Reliability 602C as a QoS attribute indicates the network's ability to consistently deliver packets without loss or corruption. This is usually particular for applications requiring constant uptime, such as remote surgery, industrial automation, and emergency response systems. A reliable network prevents data loss, minimizes retransmissions, and enhances system 200 performance under varying network conditions. However, achieving high reliability often requires redundancy mechanisms such as error correction and retransmission protocols, which increase overhead. In emergency communication networks, reliability 602C establishes critical alerts that reach responders without fail, improving situational awareness and response times. For example, in autonomous vehicle communication, if reliability 602C falls below 99.999% vehicles may fail to receive critical navigation updates, leading to potential accidents.

Network capacity 602D as a QoS attribute defines the total amount of data a network handles at any given time. A high network capacity allows multiple devices to operate simultaneously without congestion. This may be useful in 5G networks, smart cities, and IoT deployments, where thousands of connected devices exchange data efficiently. If the network capacity is insufficient, congestion may lead to degraded performance and slower data transmission. In a 5G-enabled autonomous vehicle network, network capacity 602D ensures multiple vehicles communicate simultaneously, preventing bottlenecks.

Packet latency 602E as a QoS attribute refers to the time taken for a data packet to travel from the source to the destination. Low latency is a requirement in applications such as online gaming, industrial automation, and telemedicine where even minor delays may have significant consequences. For example, in an autonomous driving system, packet latency 602E must be kept below 1 millisecond for sensor data to reach the vehicle's control unit in time for rapid decision-making. High latency may result in delayed responses, leading to inefficiencies or even system failures. To minimize packet latency 602E, the system 200 prioritizes time-sensitive packets, optimizes transmission routes, and reduces unnecessary data processing.

Bandwidth 602F as a QoS attribute represents the maximum data transfer capacity of a network. A high-bandwidth network allows large volumes of data to be transmitted simultaneously. Sufficient bandwidth maintains seamless video conferencing, cloud computing, and large-scale data processing. If bandwidth 602F is limited, an AI-driven smart home system may struggle to process simultaneous voice commands, camera feeds, and IoT sensor data. However, bandwidth allocation may be carefully managed to prevent network congestion. In a real-time sports broadcasting system, high bandwidth supports that 4K ultra-HD video feeds are transmitted without buffering or loss of quality. If bandwidth is poorly managed, lower-priority applications may experience slowdowns.

Response time 602G as a QoS attribute defines how quickly a system reacts to incoming requests. In AI-driven automation and smart grid systems, fast response times are used to process real-time data and take corrective actions. For example, in financial trading platforms, response times must remain below 100 milliseconds to execute trades efficiently, preventing price fluctuations from affecting transactions. A delayed response in an AI-based fraud detection system may result in unauthorized transactions being processed. The system 200 reduces response time 602G by optimizing data processing mechanisms, improving computational efficiency, and prioritizing urgent requests.

Energy efficiency 602H as a QoS attribute refers to how effectively a network utilizes power while maintaining performance. This may be particularly useful for battery-operated IoT devices, mobile networks, and green data centers, where reducing power consumption extends device lifespan and lowers operational costs. For example, in a solar-powered IoT network for agricultural monitoring, optimizing energy efficiency ensures sensors operate longer without battery depletion. The system 200 improves energy efficiency by using sleep modes, optimizing data transmission intervals, and reducing redundant computations. However, aggressive power-saving measures may impact response times, requiring a balance between energy conservation and performance.

In addition to the QoS attributes illustrated in FIG. 6, various QoS attributes may also be considered for network performance and optimizing resource allocation. These may include packet loss rate, which measures the percentage of lost or dropped packets during transmission, availability, ensuring the network remains operational for a specified percentage of time, and scalability, which determines the network's ability to handle an increasing number of devices and traffic loads. Security-related QoS attributes, such as encryption overhead and authentication latency.

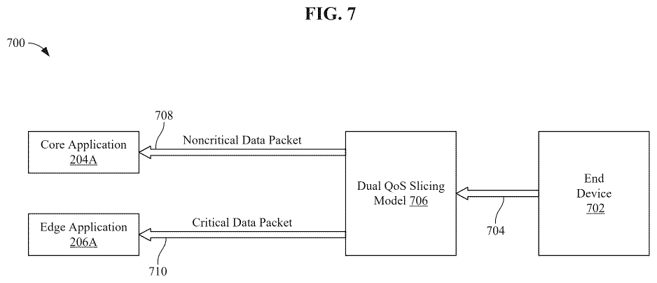

FIG. 7 is a diagram that illustrates a framework 700 for the transmission of data packets, in accordance with an embodiment of the disclosure. FIG. 7 is explained in conjunction with elements from FIGS. 1 and 2. The framework 700 begins with an end device 702 generating a data stream 704 including a plurality of data packets. The data stream 704 refers to a continuous flow of digital information transmitted from the end device to the network. The data stream 704 contains multiple data packets or a plurality of data packets, each carrying specific pieces of information. The data packets may include sensor readings, control signals, multimedia content, telemetry data, or transactional requests, depending on the type of end device and its application. According to some embodiments, the end device 702 may include various types of user-operated or automated devices, such as smartphones, IoT sensors, industrial robots, autonomous vehicles, or medical monitoring systems. The end device 702 may continuously produce data packets for transmission through the network for further processing and decision-making.

The data stream 704 containing a plurality of data packets reaches the dual QoS slicing model 706, which classifies each data packet of the plurality of data packets based on their level of criticality. The dual QoS slicing model 706 determines the criticality index of each data packet of the plurality of data packets by assigning scores and generates a network slice by creating a logical partition for each data packet of the plurality of data packets and allocating the network resources to the logical partition for each data packet of the plurality of data packets. The dual QoS slicing model 706 further routes the data packet to either one of a network sub-slice or an application sub-slice. The classification is for optimizing network resource allocation and ensuring the time-sensitive data packet is processed without unnecessary delays. The dual QoS slicing model 706 evaluates each data packet of the plurality of the data packets and determines whether the data packet is to be treated as a non-critical data packet 708 or a critical data packet 710. In this regard, the dual QoS slicing model 706 obtains the criticality index of each data packet and compares it with a criticality threshold to ascertain the data packet as critical or non-critical in a manner described with respect to FIG. 3. If the data packet is classified as critical, it is routed to the edge application 206A for further processing. The edge application 206A may be deployed closer to the end device 702, typically within edge servers, base stations, or gateway devices. Processing data at the edge application 206A reduces latency and provides real-time operations that are not affected by network congestion or delays. The critical data packet 710 may include one or more of real-time sensor data, emergency alerts, industrial automation signals, and vehicle control commands, which require an immediate response.

If the data packet is classified as non-critical data packet 708, it is transmitted to the core application 204A. The core application 204A is hosted in a centralized cloud infrastructure or data center, where it handles large-scale processing and long-term storage. The non-critical data packets 708 may include scheduled software updates, historical data logs, telemetry data, or bulk file transfers, which do not require immediate action. For example, in an autonomous vehicle network, the end device 702 may be a self-driving car that continuously generates data from its sensors. The dual QoS slicing model 706 may analyze the data stream 704 consisting of a plurality of data packets and classify the data packets accordingly. Critical data packets 710, such as real-time LiDAR inputs, collision detection alerts, and emergency braking commands, may be sent to the edge application 206A for instant decision-making. Meanwhile, non-critical data packets 708, such as historical driving patterns, periodic map updates, and vehicle diagnostics, may be routed to the core application 204A for future analysis. When the classification and routing are complete, the respective applications process the data accordingly. The edge application 206A ensures that critical tasks are executed with minimal delay, maintaining system 200 reliability and responsiveness. Meanwhile, the core application 204A performs deeper analysis and storage, optimizing long-term network efficiency. The transmission of a data packet to the edge application 206A or the core application 204A includes resource allocation for transmission of the corresponding data packet. The resource allocation may be executed by the dual QoS slicing model 706 or a suitable network device in the manner described previously with respect to FIGS. 3 and 5B.

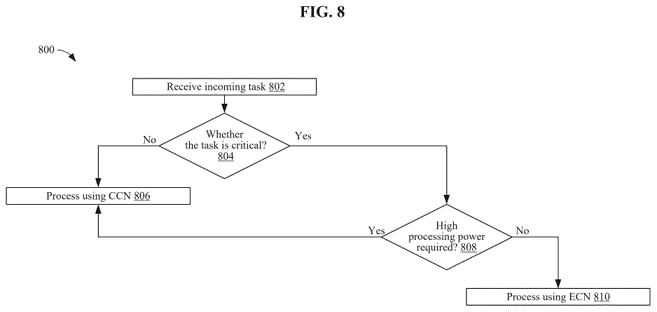

FIG. 8 is a diagram that illustrates a flowchart 800 of the data packet routing process 408 for routing data packets based on processing power, in accordance with an embodiment of the disclosure. FIG. 8 is explained in conjunction with elements from FIGS. 1, 2, and 4. With reference to FIG. 8, the flowchart 800 illustrates exemplary operations from 802-810, as described herein. The exemplary operations 802-810 may be executed by any system, apparatus, or device. Although illustrated with discrete blocks, the exemplary operations associated with one or more blocks of the data packet routing process 408 may be divided into additional blocks, combined into fewer blocks, or eliminated, depending on the particular implementation. FIG. 8 illustrates an embodiment where in addition to the criticality index of a data packet, the processing power requirement of the data packet is also considered to route the data packet.

The flowchart 800 comprises an operation 802 for receiving an incoming task. The incoming task may be parameterized or represented as a data packet or computational request entering the system 200. The incoming task may originate from any source such as an IoT device, a user application, or network components requiring processing. The flowchart 800 comprises an operation 804 to evaluate whether the incoming task is critical. In this regard, the system 200 may assess an urgency, real-time requirements, and potential impact on the overall network operation for the incoming task. If the incoming task is not critical, the incoming task is directly processed using the core computing node (CCN) at operation 806. The CCN is typically a centralized processing unit, such as a cloud server or a data center, which handles bulk processing tasks that do not require immediate action. The tasks may include batch processing, data analytics, or delayed computations.

However, if the incoming task is evaluated to be critical, the system 200 further analyses whether high processing power is required at operation 808. For critical tasks that do not require high processing power, the system 200 processes the incoming critical tasks using the edge computing node (ECN) at operation 810. The ECN is situated closer to the data source than the CCN. For example, the ECN may be hosted on edge servers, base stations, or gateway devices. The ECN is responsible for handling tasks that demand low latency and real-time processing, such as autonomous vehicle control, industrial automation, or remote healthcare monitoring. However, if the critical task requires high processing power (i.e., the result of the evaluation at operation 808 is yes), the critical task is redirected to the CCN for processing at operation 806. High processing power may be needed for tasks such as AI model training, complex simulations, and large-scale data aggregation, which exceed the computational capabilities of edge nodes.

Some embodiments are directed towards meeting quality of service (QoS) requirements for all types of data packets, regardless of whether they are classified as critical or non-critical. The system 200 verifies each data packet of the plurality of data packets is processed based on its specific QoS attributes, such as latency, throughput, reliability, and bandwidth efficiency. Instead of prioritizing only critical tasks, the framework illustrated in flowchart 800 dynamically manages network resources to optimize performance for all data transmissions. For instance, while critical data packets may require low latency and high reliability, non-critical packets still demand efficient handling.

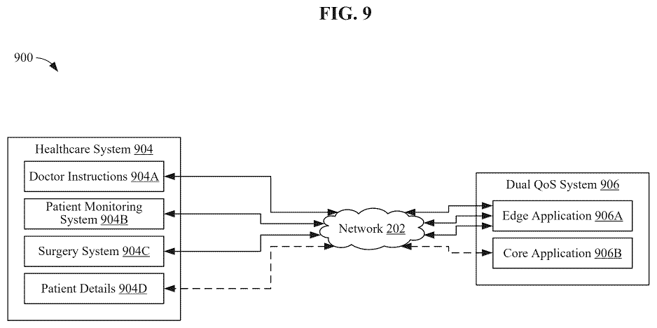

FIG. 9 is a diagram that illustrates an example use case for network slice generation, in accordance with an embodiment of the disclosure. FIG. 9 is explained in conjunction with elements from FIG. 1-8. FIG. 9 illustrates an environment 900 for implementing network slice generation in a healthcare system 904, utilizing a dual QoS system 906, according to some embodiments. The environment 900 showcases a healthcare system 904 which includes a module for storing doctor instructions 904A, a patient monitoring system 904B, a surgery system 904C, and a module for storing patient details 904D. The environment 900 further includes the network 202 of FIG. 2. The environment 900 further includes a dual QoS system 906 which includes an edge application 906A and a core application 906B. The network 202 serves as the medium for data exchange between the healthcare system and the dual QoS system 906, ensuring different types of medical data are transmitted and processed according to their specific quality of service (QoS) requirements.

The healthcare system 904 includes multiple components generating and transmitting data over the network 202. One such component is the module for storing doctor instructions 904A, which contain medical directives from healthcare professionals. The doctor instructions 904A need to be transmitted with high reliability and low latency for timely execution, particularly in emergency scenarios. Additionally, the patient monitoring system 904B continuously tracks vital signs and various health parameters, requiring real-time data transmission to prevent delays in critical medical interventions. Additionally, the surgery system 904C may involve remote surgical operations, robotic-assisted procedures, or telemedicine-based interventions. The tasks of the surgery system 904C demand extremely low latency and high network reliability to maintain precision and accuracy. The patient details 904D includes electronic health records, medical history, and administrative data. While the information is required, it is less latency-sensitive and may be processed with a lower priority compared to real-time medical procedures.

The network 202 routes healthcare data to the dual QoS system 906, which includes two distinct networks to handle different processing requirements. The edge application 906A manages time-sensitive tasks such as real-time patient monitoring, surgical assistance, and doctor instructions. By processing data closer to the source, the edge application 906A minimizes latency and provides rapid response times, which is required for medical applications requiring immediate attention. The core application 906B is utilized for tasks requiring significant computational power but tolerates higher latency. The tasks may include medical record storage, data analytics, and non-urgent medical updates. By processing such data centrally, the core application 906B affirms computationally intensive tasks are handled efficiently while optimizing the use of network resources.

The dual QoS system 906 processes the transmitted data, and the healthcare system 904 receives the output based on the specific network slice assigned to each task. For instance, if the doctor instructions 904A are transmitted through the edge application 906A, the healthcare system 904 immediately executes the received directives, for medical professionals. Similarly, for the patient monitoring system 904B, real-time feedback is generated, allowing healthcare providers to assess a patient's condition instantly and take required actions if abnormal health parameters are detected. In cases where surgical procedures rely on real-time robotic assistance, the received data ensures precise control commands are executed without noticeable delay, maintaining operational accuracy. Meanwhile, non-urgent tasks such as patient details 904D, processed through the core application 906B, are stored in hospital databases or analyzed for medical research and administrative purposes. This provides that healthcare providers retrieve patient history, update medical records, and conduct long-term assessments without disrupting real-time medical operations.

In this way, various example embodiments of the disclosure provide a technical solution to the problem of reducing latency in data communication. By providing a criticality-based slice allocation approach, various embodiments lead to efficient utilization of available network resources while meeting the requirements of time-critical applications.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable one of ordinary skill in the art to understand the embodiments disclosed herein.

What is claimed is:

1. A computer-implemented method, comprising:
receiving, by a computer, a data stream comprising a plurality of data packets;
obtaining, by the computer, a criticality index for each data packet of the plurality of data packets, wherein the criticality index for each data packet of the plurality of data packets indicates a measure of criticality of a processing task associated with a corresponding data packet of the plurality of data packets;
generating, by the computer, a network slice of a communication network for the data stream, based on the criticality index of each data packet of the plurality of data packets, wherein the network slice comprises a sub-slice for each data packet of the plurality of data packets; and
routing, by the computer, each data packet of the plurality of data packets to a processing application of the communication network based on the sub-slice of a corresponding data packet of the plurality of data packets.

2. The computer-implemented method of claim 1, further comprising controlling, by the computer, a transmitter to transmit each data packet of the plurality of data packets over the sub-slice of a corresponding data packet of the plurality of data packets.

3. The computer-implemented method of claim 1, wherein the obtaining of the criticality index for each data packet of the plurality of data packets comprises:
extracting, by the computer, the criticality index of each data packet of the plurality of data packets from a corresponding data packet of the plurality of data packets.

4. The computer-implemented method of claim 1, wherein the obtaining of the criticality index for each data packet of the plurality of data packets comprises:
receiving, by the computer, the criticality index of each data packet of the plurality of data packets from at least one edge computing node of the communication network,
wherein the at least one edge computing node is configured to:
process each data packet of the plurality of data packets based on a classification engine; and
determine the criticality index for each data packet of the plurality of data packets based on the processing of a corresponding data packet of the plurality of data packets.

5. The computer-implemented method of claim 1, wherein the generating of the network slice for the data stream comprises:
creating, by the computer, a logical partition of the communication network for each data packet of the plurality of data packets;
determining, by the computer, at least one desired Quality of Service (QoS) attribute for each data packet of the plurality of data packets, based on the criticality index of a corresponding data packet of the plurality of data packets; and
allocating, by the computer, network resources to the logical partition for each data packet of the plurality of data packets, based on the at least one desired QoS attribute of a corresponding data packet of the plurality of data packets.

6. The computer-implemented method of claim 5, wherein
the plurality of data packets comprises a first data packet and a second data packet,
the criticality index of the first data packet is higher than the criticality index of the second data packet, and
the allocating of the network resources to the logical partition for each data packet of the plurality of data packets comprises:
determining, by the computer, a solution to an optimization problem defined by at least one dynamic network attribute of the communication network and a weighted sum of the at least one desired QoS attribute of each of the first data packet and the second data packet, wherein an objective function of the optimization problem includes maximizing a probability of satisfying the at least one desired QoS attribute of the first data packet; and
allocating, by the computer, the network resources to the logical partition for each of the first data packet and the second data packet, based on the solution to the optimization problem.

7. The computer-implemented method of claim 5, further comprising:
monitoring, by the computer, one or more QoS parameters in the network slice; and
altering, by the computer, the network resources for the logical partition of at least one data packet of the plurality of data packets, based on a violation of a threshold condition by the one or more QoS parameters in the network slice.

8. The computer-implemented method of claim 1, wherein
the processing application includes one of an edge application of the communication network or a core application of the communication network,
at least one edge computing node of the communication network hosts the edge application, and
at least one cloud computing node of the communication network hosts the core application.

9. The computer-implemented method of claim 8, wherein
the sub-slice for each data packet of the plurality of data packets is one of a network sub-slice or an application sub-slice,
the network sub-slice supports end-to-end communication between a client device and the at least one cloud computing node of the communication network, and
the application sub-slice supports end-to-edge communication between the client device and the at least one edge computing node of the communication network.

10. A computer system, comprising:
a processor set;
one or more computer-readable storage media; and
program instructions stored on the one or more computer-readable storage media, the program instructions executable by the processor set to cause the processor set to:
receive a data stream comprising a plurality of data packets, wherein each data packet of the plurality of data packets comprises a criticality index that indicates a criticality of a processing task associated with a corresponding data packet of the plurality of data packets;
generate a network slice of a communication network for the data stream, based on the criticality index of each data packet of the plurality of data packets, wherein the network slice comprises a sub-slice for each data packet of the plurality of data packets; and
route each data packet of the plurality of data packets to a processing application of the communication network based on the sub-slice of a corresponding data packet of the plurality of data packets.

11. The computer system of claim 10, wherein the program instructions further cause the processor set to control a transmitter to transmit each data packet of the plurality of data packets over the sub-slice of a corresponding data packet of the plurality of data packets.

12. The computer system of claim 10, wherein to generate the network slice for the data stream, the program instructions cause the processor set to:
create a logical partition of the communication network for each data packet of the plurality of data packets;
determine at least one desired Quality of Service (QoS) attribute for each data packet of the plurality of data packets, based on the criticality index of a corresponding data packet of the plurality of data packets; and
allocate network resources to the logical partition for each data packet of the plurality of data packets, based on the at least one desired QoS attribute of a corresponding data packet of the plurality of data packets.

13. The computer system of claim 12, wherein
the plurality of data packets comprises a first data packet and a second data packet, the criticality index of the first data packet is higher than the criticality index of the second data packet, and
to allocate the network resources to the logical partition for each data packet of the plurality of data packets, the program instructions cause the processor set to:
determine a solution to an optimization problem defined by at least one dynamic network attribute of the communication network and a weighted sum of the at least one desired QoS attribute of each data packet of the first data packet and the second data packet, wherein an objective function of the optimization problem includes maximization of a probability of satisfaction of the at least one desired QoS attribute of the first data packet; and
allocate the network resources to the logical partition for each data packet of the first data packet and the second data packet, based on the solution to the optimization problem.

14. The computer system of claim 12, wherein the program instructions further cause the processor set to:
monitor one or more Quality of Service (QoS) parameters in the network slice; and
alter the network resources for the logical partition of at least one data packet of the plurality of data packets, based on a violation of a threshold condition by the one or more QoS parameters in the network slice.

15. The computer system of claim 10, wherein
the processing application is one of an edge application of the communication network or a core application of the communication network,
at least one edge computing node of the communication network hosts the edge application, and
at least one cloud computing node of the communication network hosts the core application.

16. The computer system of claim 15, wherein
the sub-slice for each data packet of the plurality of data packets is one of a network sub-slice or an application sub-slice,
the network sub-slice supports end-to-end communication between a client device and the at least one cloud computing node of the communication network, and
the application sub-slice supports end-to-edge communication between the client device and the at least one edge computing node of the communication network.

17. A computer-program product for data communication in a communication network, the computer-program product comprising:
one or more computer-readable storage media; and
program instructions stored on the one or more computer-readable storage media to perform operations comprising:
receiving a data stream comprising a plurality of data packets;
obtaining a criticality index for each data packet of the plurality of data packets, wherein the criticality index for each data packet of the plurality of data packets indicates a measure of criticality of a processing task associated with a corresponding data packet of the plurality of data packets;
generating a network slice of the communication network for the data stream, based on the criticality index of each data packet of the plurality of data packets, wherein the network slice comprises a sub-slice for each data packet of the plurality of data packets; and
routing each data packet of the plurality of data packets to a processing application of the communication network based on the sub-slice of a corresponding data packet of the plurality of data packets.

18. The computer-program product of claim 17, wherein the operations further comprise controlling a transmitter to transmit each data packet of the plurality of data packets over the sub-slice of a corresponding data packet of the plurality of data packets.

19. The computer-program product of claim 17, wherein the obtaining of the criticality index for each data packet of the plurality of data packets comprises:
extracting the criticality index of each data packet of the plurality of data packets from a corresponding data packet of the plurality of data packets.

20. The computer-program product of claim 17, wherein the obtaining of the criticality index for each data packet of the plurality of data packets comprises:
receiving the criticality index of each data packet of the plurality of data packets from the at least one edge computing node,
wherein the at least one edge computing node is configured to:
process each data packet of the plurality of data packets based on a classification engine; and
determine the criticality index for each data packet of the plurality of data packets based on the processing of a corresponding data packet of the plurality of data packets.
